(19) United States
(12) Patent Application Publication
(10) Pub. No.: US 2005/0280555 A1
(43) Pub. Date: Dec. 22, 2005

(54) Mathods & apparatus dynamically managing parking

(76) Inventor: Frederick Maltby Warner IV, Emeryville, CA (US)

Correspondence Address: Steven M. Santisi;IP Design & Development Group, LLC, 80 Lounsbury Lane, Ridgefield, CT, 06877, US

(21) Appl. No.: 11/158,991

(22) Filed: Jun. 22, 2005

Related U.S. Application Data
(60) Provisional application No. 60/582,324, filed on Jun. 22, 2004.
(60) Provisional application No. 60/624,278, filed on Nov. 2, 2004.

(51) Int. Cl. B60Q 1/48; G08G 1/14

(52) U.S. Cl. 340/932.2; 705/13

(57) ABSTRACT

A dynamic parking management system and method includes use of an intelligent software engine that, in some embodiments, interfaces with a wireless mesh network and multi-channel communication devices that, as a system, increases customer convenience which maximizes return on parking resources. The present invention uses a parking transceiver mesh network node located proximate to one or more parking spaces to provide accurate and current data to a database of available parking assets. Parking availability algorithms are used to analyze this data to select optimal parking spaces for subscribers/drivers and predict future availability of parking spaces. Additional functionality comes from the parking transceiver's ability to recognize specific vehicles and specific customers with predefined requirements.

### CROSS-REFERENCE TO RELATED APPLICATIONS

The present invention claims priority to U.S. Provisional Application No. 60/582,324 entitled “METHODS AND APPARATUS FOR DYNAMICALLY MANAGING PARKING” filed June 22, 2004 and U.S. Provisional Application No. 60/624,278 also entitled “METHODS AND APPARATUS FOR DYNAMICALLY MANAGING PARKING” filed Nov. 1, 2004, which are both hereby incorporated herein by reference for all purposes.

### FIELD OF THE INVENTION

The present invention relates generally to parking management, and more specifically, to systems and methods for aiding drivers to find parking.

### BACKGROUND

Finding parking in high-density, multi use environments, such as urban centers, airports and transit stations can be frustrating and inefficient for today's commuters. As population densities increase, adequate parking becomes more scarce. Even when there is adequate parking available, locating a spot a reasonable walking distance from the ultimate destination can be difficult and/or time consuming. Prior art attempts to remedy such problems have not provided a complete solution that allows parking authorities/providers to cost effectively apply all available parking and information resources.

Thus, what is needed is a practical system that could identify available parking, guide the driver to the space and handle payments would speed the task of finding parking. What is further needed is cost-effective, easily usable real time and accurate information to help drivers get from point A to B in a more effective fashion.

### SUMMARY OF THE INVENTION

The present invention overcomes the above and other drawbacks of the prior art by offering systems and methods for dynamically managing parking.

In a first aspect, the present invention includes the use of a real-time self-configuring, mesh network for sensing and communicating the status of parking spots to aid in the automated management and optimization of parking spot inventory over a wide geographic area. The mesh networking along with appropriate back-end systems provides support for determining and communicating parking spot availability, marketing, reservations, payment, enforcement, and monitoring.

In a second aspect, the present invention provides a system wherein self-contained parking sensors may be provided to individual parking spot owners so that they can automatically join the mesh network to rent their spot. This aspect allows a municipality, for example, to cost effectively add private parking resources to the total parking inventory.

In a third aspect, the present invention provides methods of predictively determining relevant information about future parking spot availability to display to remote vehicles passing changeable signs on roadways, or in other highly visible locations, or by other means of communication accessible to the operator of a vehicle, (e.g., over mobile search engines and voice based information systems such as 511). In other words, the present invention may be able to communicate anticipated parking spot availability to drivers traveling toward an area which is much more relevant than current parking availability when the driver is still half an hour away from the destination. By using a stochastic and/or deterministic modeling based server system that works in concert with multiple counting methods and multiple communication methods unique and useful information may be dynamically created.

The above and other features of the invention will become more readily apparent from the following detailed description accompanied by the following drawings.

### BRIEF DESCRIPTION OF THE DRAWINGS

FIG. 1 depicts an example embodiment of a system according to some embodiments of the present invention.

FIG. 2 depicts example embodiments of access points for using the system depicted in FIG. 1.

FIG. 3 depicts an example of a web based access page for using the system depicted in FIG. 1.

FIG. 4 depicts example embodiments of sensors and/or mesh network nodes for use with the system depicted in FIG. 1.

FIG. 5 depicts an alternative example embodiment of a sensor and/or mesh network node for use with the system depicted in FIG. 1.

FIG. 6 depicts an example embodiment of a changeable message sign being used to display real-time and/or predicted parking asset inventory availability information according to some embodiments of the present invention.

FIG. 7 depicts an example embodiment of various communication channels employed in some embodiments of the system of the present invention.

FIG. 8 depicts an image of an example embodiment of a standard loop detector enhanced internally with an add-on module according to some embodiments of the present invention.

FIG. 9 depicts an example embodiment of a parking transceiver mesh network configuration for a small parking lot according to some embodiments of the present invention.

FIG. 10 depicts an example shape of a parking transceiver node housing according to some embodiments of the present invention.

FIG. 11 is a flowchart depicting an example embodiment of a process level view of a parking transceiver's communication with the system of the present invention.

FIG. 12 is a block diagram depicting an example of the information packet that may be transmitted by and between parking transceiver mesh network nodes according to some embodiments of the present invention.

### DETAILED DESCRIPTION OF THE INVENTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices. The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

The present invention includes a dynamic parking management system for maximizing parking utilization and convenience that improves the way parking works in our communities. This is accomplished by leveraging new and established technologies in a new and unique fashion. The telematics developments over the past few years coupled with technologies such as wireless services, mobile phones, the web, and the growth and acceptance of proprietary services (e.g. FasTrak® by CalTrans, OnStar® by General Motors Corp., Speedpass® by Mobil) enable the present invention's service to manage parking resources in a new and unique fashion.

The present invention may be implemented as a consumer based dynamic parking management system that maximizes parking convenience and utilization. The inventors have recognized the following problems that currently exist with conventional parking. Currently there is: pervasive inefficient use of parking resources, user inconvenience, poor utilization of parking space inventories, traffic congestion as users seek available space, lost revenues due to the lack of means to proactively reach customers, lost revenues due to the high cost of rogue parking (e.g. illegal parking, parking without paying), opportunity cost of creating additional parking (e.g., for both private and public sectors), parking restrictions are generally over-broad which leads to punitive enforcement, and negative environmental impacts due to construction and increased vehicle miles traveled (VMT). More details regarding the problems and costs associated with existing parking systems may be found in the current “State of California Transit Plan”, the University of California at Berkeley “Smart Parking Study”, and the “Parking Management Operations Study” by IPI, all three of which are hereby incorporated herein in their entirety for all purposes.

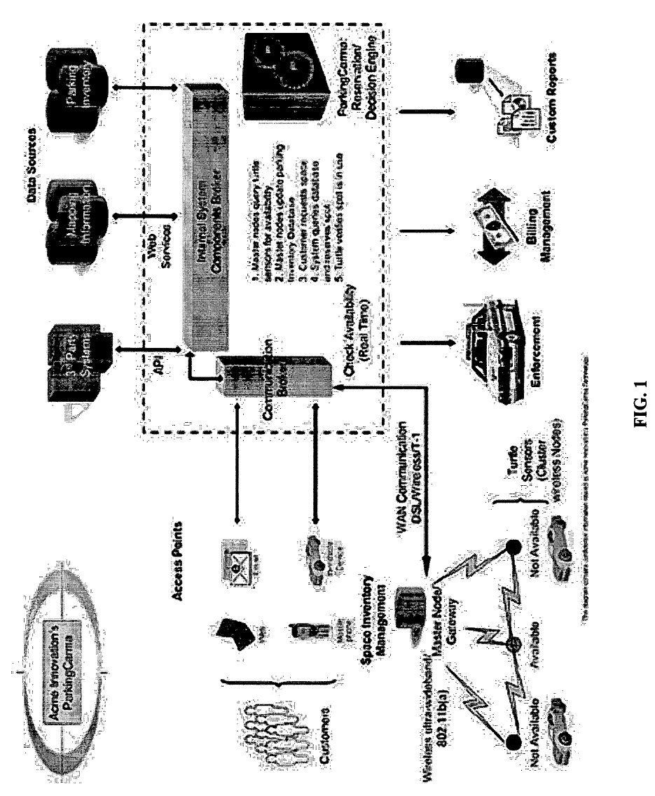

The inventors have invented systems and methods that include an intelligent software engine that, in some embodiments, interfaces with a wireless micro-mesh network and multi-channel communication devices that, as a system, increase customer convenience which maximizes return on parking resources. The present invention uses a “parking transceiver” located proximate to one or more parking spaces to provide accurate and current data to a database of available parking assets. Additional functionality comes from the parking transceiver's ability to recognize specific vehicles and specific customers. FIG. 1 depicts an example system according to some embodiments of the present invention.

Many parties may benefit from the systems and methods of the present invention. Consumers may benefit from: increased parking availability in dense retail and residential communities, automated real-time information and guidance to available and the most convenient parking; the convenience of cashless payment (e.g. credit card or mobile phone monthly billing, draw down accounts); only having to pay for actual use (and any added benefits); higher availability of parking through “dynamic space sharing”; support for a reservation system for both last minute and planned events as well as premium spaces, increased security of their parked vehicles, reduced congestion, and reduced environmental impact of growth.

Private (e.g. off street) parking providers may benefit from the present invention in a number of ways. Operators of the inventive systems enjoy an improved competitive position; the ability to reach (e.g. solicit) the customer in route; real-time matching of users to providers; the use of software designed from the customers view point without the in-house cost of development; the opportunity to earn premium service revenues without substantially increasing cost of operations; increased revenue through higher utilization of parking space assets; the opportunity to offer value based pricing; revenue management opportunities; automated billing that reduces cost of onsite payment and collection; and opportunities for enhanced community relationships via the improved safety and environmental impact of the system over conventional systems.

Public (e.g. on street) parking providers may benefit from better commuter information via congestion reduction and enhanced/optimized city infrastructure usage; increased revenue through higher utilization of parking space assets for communities and their constituents; the elimination of lost revenue from expired parking passes and other non-paying customers; the opportunity to offer value based pricing; revenue management opportunities; opportunities to easily and inexpensively collect important and valuable data for city planning purposes; automated billing reduces the cost of onsite payment collection; the provider may earn premium service revenues without substantially increasing cost of operations; and the present invention presents providers with an opportunity for enhanced community relationships via the improved safety and environmental impact of the system over conventional systems.

The present invention may benefit the automotive industry by allowing consumers to enjoy an improved driving experience, the availability of a compelling information application for telematics (since everyone needs to park and pay for it); improving the driving experience by minimizing use of the automobile in inter-modal commutes; providing conveniences that offset the increasing cost of driving; providing increased driving safety; and enhanced community relationships (safety and environmental).

The present invention may benefit the telecommunication industry by providing increased revenue through a useful application for wireless services; low bandwidth utilization for a high customer value even as the service scales; an opportunity to profit from “hot spot data fueling” (e.g. at personal computers and vehicles with on-board computing resources); a catalyst for additional applications once vehicle services become pervasive; and profits from the vehicle industry and state governments building digital enhanced cordless telecommunications (DECT) packet radio services (DPRS).

In some embodiments, the present invention may include a self-configuring micro-mesh network, a reservation and decision engine, and communication brokers. A pervasive wireless micro-mesh network may be used. Such a network may include low-cost self-contained transceivers that can integrate with existing sensors, road-bed mesh parking transceivers each associated with individual parking spaces, mesh parking Internet gateways associated with one or more parking transceivers, a self-configuring system for establishing communication paths between parking transceivers and parking Internet gateways, support for various user interfaces including handheld devices, changeable message signs (CMS), and onboard vehicle computers (e.g. OnStar® enhanced global positioning system (GPS) systems, etc.). In addition, a micro-mesh network may include expansion features to provide additional mobile services An example of a parking transceiver suitable for use with some embodiments of the present invention may include a transmitter and receiver capable of communicating with other parking transceivers located 300 meters or more away. In some embodiments, shorter-range transceivers may be used to conserve power consumption. In some embodiments, unlicensed radio frequencies or other FCC approved wireless or wired communications mediums may be used. In some embodiments, suitable parking transceivers may communicate at a ten megabit per second data transfer rate, however, in some embodiments, much slower rates maybe also be used. The physical structure of a parking transceiver may be constructed to be able to withstand a very high level of abuse (e.g. vandalism, extremely over-weight vehicles, etc.) and may outwardly appear to merely be an ordinary road reflector. In some embodiments, suitable parking transceivers may include vehicle sensing capabilities as well as an interface for communicating with sensors on-board vehicles. Parking transceivers may also include built in security features such as encrypted communications facilities, tamper evident and resistant enclosures, and password-protected access to information. In some embodiments, parking transceivers are self-contained, low power, large-scale integration (LSI) (e.g. complementary metal oxide semiconductor (CMOS)) devices with an integrated antenna. Components used in manufacturing may be chosen so as to be commonly available from multiple vendors to minimize the cost. In some embodiments, suitable parking transceivers may include a self-renewing power supply with a five to ten year life cycle such as a solar panel that recharges a battery.

The system of the present invention may be implemented using low cost components. For example, suitable parking transceivers may be manufactured in large quantities such that the cost per parking transceivers may be recouped within only a few cycles of rented an associated parking space. Likewise, parking Internet gateways may also be manufactured such that the cost per parking Internet gateway is relatively low.

The present invention is a solution born from the convergence of the Internet maturing, the parking industry looking for contracted computer services, the ubiquity of wireless services, and increasing congestion. The present invention is a usable, practical, and deployable product that supports transportation management and user needs. Further, the present invention increases commuter ridership on public transportation (e.g. trains, ferries, rideshare systems, buses, etc.) that provides parking managed by the present invention, and, at the same time, provides better utilization of fixed parking assets such as multi-level garages and parking lots.

In some embodiments, the present invention may be used to provide access to locations for federally mandated rest time for long-haul truck drivers and others in highway rest stops, on-street or other suitable parking spots. Governmental agencies and private parking companies may implement the present invention using similar technology as for automobile on-street parking to provide parking services to truck drivers.

Under new federal rules for trucking, truck drivers may drive eleven hours after ten hours off duty. The old rule that expired in early 2004 allowed operators to drive ten hours after eight hours off duty. While permitting actual driving for eleven hours, the rules state a truck driver may be “on duty” for up to fourteen consecutive hours (“on-duty” time includes meal breaks, for example, during which the truck driver is not actually driving).

Trucking industry experts anticipate that drivers parking more often and for longer periods of time will create an acute shortage of parking spaces for trucks across the nation.

In 2002, there were about 4,900 truck-related fatalities in traffic accidents around the United States, according to agency statistics. Safety administration officials estimate that the new regulations will save as many as 75 lives and prevent as many as 1,326 fatigue-related trucking accidents annually.

Many things have changed in the motor carrier industry since 1939 when the original hours-of-service (HOS) regulations were prescribed for truck drivers. Roads are better designed, constructed, and maintained in a nationwide network to provide greater mobility, accessibility, and safety for all highway users. Vehicles have been dramatically improved in terms of design, construction, safety, comfort, efficiency, emissions, technology, and ergonomics. These factors, combined with years of driver fatigue and sleep disorder research, have led to a revision of the HOS regulations for drivers, a very important component of trucks operating on the highway.

Reform of the HOS regulations has been under consideration by the Federal Motor Carrier Safety Administration (FMCSA) for several years. In 1995, Congress, concerned about the effect of fatigue as a contributing factor in commercial motor vehicle crashes, directed the FMCSA to begin rulemaking to increase driver alertness and reduce fatigue-related incidents.

In response to the Congressional directive, FMCSA analyzed the scientific research, convened expert panels, held hearings and roundtable discussions, and reviewed over 53,000 individual comments submitted during the rulemaking process. In April 2003, FMCSA issued the first significant revision to the HOS regulations in over 60 years. The new regulations provide an increased opportunity for drivers to obtain necessary rest and restorative sleep, and at the same time reflect operational realities of motor carrier transportation.

Thus, as the economy grows and the new rules are enforced, the need for parking for trucks is very likely to increase substantially.

System Architecture

The architecture of the present invention provides a quickly deployable product geared toward target geographic markets but many scalability considerations are addressed. The present invention's platform software architecture, (the program), enables delivering revenue managed parking applications and may support many additional objectives.

The present invention may provide enterprise-class scalability and availability. The program supports deployment in mission-critical environments with thousands of concurrent users and 24×7 availability. The program does not introduce any inherent scalability/availability limitations. The program's applications and various modules are deployable across web server, application server and database server clusters as dictated by performance and availability requirements of particular embodiments.

The program enables integration with existing legacy applications, and third party gateways. The architecture contemplates and supports a clear and defined integration strategy with proprietary parking services systems as well as well as technology to accommodate all variances in local parking ordinances.

The architecture allows the leveraging of third party products and services. In order to offer increasingly compelling and feature-rich applications, the program provides, to the extent practicable, the ability to add third party products and technology without requiring extensive re-engineering work. In some embodiments, it may be desirable to allow several implementations of third party products to coexist. For example, this could include, TellME® networks, OnStar®, Vindago®, SignalPark-USA ,Inc., Iparg billing systems, Federal ADP gating and parking management systems, Sheidet & Bachmann on street and off street gating and metering systems, Parkeon shared meter systems, MeterTek wireless parking solutions, etc.

Some embodiments of the invention provide support for different licensing models. In some embodiments, the program and subsystems may be sold as building blocks for original engineering manufacturers (OEMS) or service partners to enable them build applications. In some embodiments, the program and subsystems may be sold in the form of a service via an application service provider (ASP). Additionally, The program may provide support for being able to manage multiple (or all, if operationally desirable) geographic areas from a single deployment environment. In some embodiments, the program and subsystems may be sold under a personalization licensing model so that a licensee may re-brand the service for specific municipalities and/or existing parking structures, parking providers, etc. The program may allow the personalization of various parameters and features. The program may allow personalizing of “look and feel”, business process, business rules/logic, security, scaleable development, and system management/monitoring, by allowing the association of custom behaviors to specific users (if desired) and/or a re-branded company's user organization.

“Look and feel” (i.e. skins) includes customization of colors and screen layout (banners, footers, navigation bars, content pane). These can be created, deployed and registered with the program and provide a custom look and feel requiring minimal (if at all) duplication of HTML, XSL, VoiceXML, or JavaScript code.

Business processes customization provides for variation in parking laws and nuances among parking authorities, parking providers, and geographic regions. The program provides a flexible component to enable building customized embodiments in different areas. The program also allows for easy definition and management of varied processes when geographic areas or multiple municipalities are running in a single instance.

Business rules/logic customization allows for specialized implementations of the program's components in both the OEM and ASP license models. While in the OEM model the custom component may be configured (patched) during installation, it is more preferable in the ASP model to provide a run-time mechanism to select the appropriate implementation. The program may thus allow for run-time pluggable implementation based on a user profile (company, group, etc.). Generally, in some embodiments, it is an architecture goal to provide data-dependent dispatching.

Security customization means that the program enforces authentication and authorization and allow for pluggable security implementations. The program may allow applications (or portions of the program) to run over the HTTPS protocol without requiring additional development. Wireless based security considerations are also addressed.

Scaleable development customization means employing widely adopted products and technologies that allow operators of the present invention to readily hire and train new developers and to lower training costs for OEMs. The program also allows developers with a specific skill set (e.g. UI designer, component developer) to be productive without knowledge of the entire system. Tools are provided (built or purchased) to minimize repetitive, labor-intensive tasks (e.g. generation of design patterns, test stubs and instrumentation).

Customization of a robust system management/monitoring features provide access to a management information base (MIB) to enable effective management and monitoring of the program and its applications. The program allows integration with leading system management vendors (e.g. HP/OpenView, Tivoli, CA Unicenter) via simple network management protocol (SNMP). A standard and error logging facility and consistent messages are used to allow integration with third party log monitoring products.

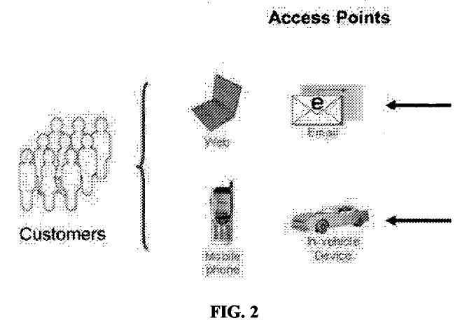

As indicated in FIG. 2, the present invention may be embodied using multiple access points on the front end. These may include cell/home phones (via an interactive voice response (IVR) system and/or speech recognition), handheld computers such as for example the PocketPC, web browsers, electronic kiosks, and the like. The middle application tier may include parking matching intelligence and interfaces to existing external (legacy) systems. This tier may also manage all inbound communication to/from remote sensors and all communication outbound to roadside changeable message signs (CMS). The back-end layer may store online transaction processing (OLTP) and online analytical processing (OLAP) databases. The databases may be configured in a cluster configuration for disaster recovery purposes. The databases may include all subscriber information for parking users, parking space providers, and associated support agencies (e.g., towing operators, valet services, safety personnel, property owners, value added service providers such as car washers, etc.). It may also contain a complete inventory of parking spaces, and specific attributes of each space.

As indicated above, the architecture may enable segmenting of users and parking spaces, allowing for re-branding or co-branding of the service for existing parking providers to provide enhanced services to their customers, such as plan ahead parking.

Access methods into the system may use an application-programming interface (API) to connect to a business logic layer and the databases. These user interfaces, including web pages, voice XML, IVR systems, etc., may use the API for ease of development and reuse of business objects. This also allows for changing of the underlying code without changing the access points. Interfaces to third party billing services (e.g. PayPal, Credit Card, Online Check, corporate account billing, commercial billing systems such as Keenan, etc.) may also be supported. The present invention may also deploy web-service based API's to support easier integration with third party systems. APIs are discussed in more detail below.

Hardware components may include individual sensors per parking space. Such sensors may include for example, infrared, sonic, radio frequency, magnetic, radar, electrical, optical, laser, etc. types of detectors/sensors. In some embodiments, to support the use of inbound IVR, speech recognition, and outbound voice, a telephony infrastructure may be implemented using ASP solutions such as TellMe Networks and/or in-house solutions such as Microsoft's Speech Server.

In some embodiments, the network infrastructure design and implementation may not be proprietary to the present invention. Such embodiments may include industry best practices for security, scalability, and disaster recovery. This may include, but is not limited to, the use of firewalls, routers, network switches, load balancers, back-up devices, console servers, network intrusion devices, etc. A data center location may be selected to further advance and support security, scalability, and disaster recovery.

As previously suggested, external interfaces include web pages, voice XML trees, PocketPC applications, changeable message sign communication, remote sensing device configuration and communication, web services, and APIs.

Parking matching and routing logic includes algorithms (e.g., parking availability algorithms) to identify optimal parking spaces for users in real time. In addition, the logic provides optimized instructions to guide users to selected parking spaces based upon numerous different parameters including traffic conditions, minimizing time and/or distance, user preferences, user characteristics such as vehicle type, etc. A parking-availability algorithm according to some embodiments of the present invention may combine multiple factors such as the inventory of parking spaces in each lot, parking reservations made within the system of the present invention and the specific nature of the user's reservation request to arrive at an optimal location for parking and/or to predict future availability of a parking space.

Legacy system integration including integration with legacy city/private parking computer systems may be implemented to whatever degree desired by the system operators. The systems and methods of the present invention may be performed using manual data gathering and entry.

Process

As indicated above, FIG. 1 is a diagram providing a system level process overview of some embodiments of the present invention. Note that this particular example diagram does not show communication with changeable message sign(s).

Description of Example System Processes in Operation:

A. Consumer User (One of Many Possible Scenarios):

1. A prospective parking consumer who has subscribed to a service implementing the present invention is running late for a meeting in a dense urban area.

2. The user dials the system of the present invention toll free number and is connected to the system.

3. The system recognizes and using an IVR system greets the user based upon the unique identifier in the user's cell phone.

4. After choosing “Find me a parking spot for today,” the user is prompted to indicate whether they want the closest spot to their current location based on geo-coding the cell phone's location or if they would like to specify a new area.

5. The user chooses to specify a new area and speaks the address in the phone.

6. The user is given a choice to override their profile search settings that were previously made via his home computer regarding to price vs. distance importance, etc. for this search. Since the user is in a hurry, he chooses the closest available space.

7. The system of the present invention may use hundreds of data points in a decision process before telling the user the options available over the phone. As indicated above, this decision process may driven by a parking-availability algorithm which may combine multiple factors such as the inventory of parking spaces in each lot, parking reservations made within the system and the specific nature of the user's reservation request to arrive at an optimal location for parking and/or to predict future availability of a parking space.

8. The user chooses an option and asks for directions.

9. The system of the present invention can either speak the directions to the user or download the directions to his personal Palm or PocketPC device. The system provides two sets of directions: (1) driving directions from the user's current location (based on the location of the user's cell phone) to the parking garage and (2) walking directions from the parking garage to the user's final destination.

10. The user pulls into the parking space and their vehicle is registered by a parking transceiver at the garage entrance and/or in the spot itself Billing commences upon registration of the user's vehicle being in the spot. A central inventory database is updated to reflect the occupied status of the parking spot.

11. The user attends his meeting and upon leaving the parking space billing is stopped if that particular spot was rented using time based billing.

12. The central inventory database is updated to reflect the available status of the parking spot.

B. Enforcement User (One of Many Possible Scenarios):

1. An enforcement agent that works in an area/municipality, which uses the system of the present invention to manage parking, arrives for his shift.

2. The enforcement agent logs into his wireless personal pocket PC or Palm device.

3. He is instantly made aware of any current and past parking infractions in areas managed by the system of the present invention with a map and directions to the specific infraction locations.

4. If applicable and if the user committing the infraction is a subscriber to a service implementing the present invention to manage parking, the enforcement agent may issue an electronic warning or ticket from the PocketPC device.

5. If the offending vehicle is owned by an entity other than a subscriber, the enforcement agent may issue a conventional printed paper ticket or report the infraction to an appropriate authority or towing service.

6. In some embodiments, towing services may be automatically dispatched by the system to remove vehicles illegally parked, for example, in front of a fire hydrant. In some embodiments, a “no parking” transceiver may be used to monitor areas where parking is prohibited.

C. Asset Owner User (One of Many Possible Scenarios):

1. The asset owner logs into their account with a system of the present invention via web based interface.

2. The user is immediately presented with a real-time system dashboard displaying the current combined status of all of their assets. (This screen is fully customizable by the user to present their most relevant information). The status information may include, but is not limited to, total asset capacity, total asset percent utilization, total revenue/profit for a particular timeframe, current and total infractions, and any other information that the system captures or is added by system operators and users.

3. The asset user can add new inventory or change values related to existing inventory. The asset owner user may enter revenue management-type offers that may be presented to consumer users by the system. For example, an asset owner may offer a free day of parking to qualified consumer users who commit to parking in a particular spot five times in the next month.

4. The asset user views trend graphical and chart information for a new parking lot and downloads the information into MS Excel documents.

D. Parking-Availability Algorithm (One of Many Possible Scenarios):

1. Static parking inventory (the count of spaces in each lot) is obtained from a reliable source (e.g. the parking manager, property owner, municipality, etc.).

2. The entrances to the parking lot (both by vehicle and on-foot) are geo-positioned using GPS or other methods.

3. A database of historical lot-inventory utilization (as calculated by the present invention using a plurality of means including counters, gates and management reports) is queried to obtain historical data and the expected lot capacity minute-by-minute is calculated for relevant future times.

4. Real-time vehicle counters in each lot are compared to the expected lot capacity to assess the likelihood of exceptional demand on the day in question.

5. The advance reservations database of the present invention is queried to determine the number of vehicles that will be expected to arrive at each lot as a result of their reservation and their anticipated time of arrival.

6. The Drive-in reservations database is queried to determine the number of vehicles having made a reservation for a given lot enroute to that location, the time the reservation was made and the geo-position of the vehicle at the time of the call.

7. The Call-in database is queried to determine the number of vehicles that have confirmed the use of a spot directly from a lot.

8. The request from a potential user of the parking lot is categorized based on a plurality of factors including their current location (geo-position), their intended destination, the anticipated duration of parking and other preferences.

9. The Parking-availability algorithm matches the user's location, destination and preferences with the expected availability of parking near their destination and suggests a location.

10. The user confirms the suggestion (or asks for other options) and way-finding information is offered.

11. The reservation is added to the applicable database and expected availability is recalculated.

12. The user proceeds to the lot and parks.

As indicated above, in some embodiments, the system of the present invention may be structured in different functional or service layers. These layers may include an access layer, a business rules/logic layer, a data layer, a communications layer, and various other layers.

Access Layer

This section breaks down the various methods enabled to access the services of the present invention. The system may use a single set of front end pages to deliver content to any device. The page will dynamically generate the appropriately formatted response based upon the device making the request. This includes voice XML, HTML, and XML.

The various access methods will be the interface into the system of the present invention. This will be the layer that users experience.

Web Based (Also Wireless Based Using the PocketPC Operating System)

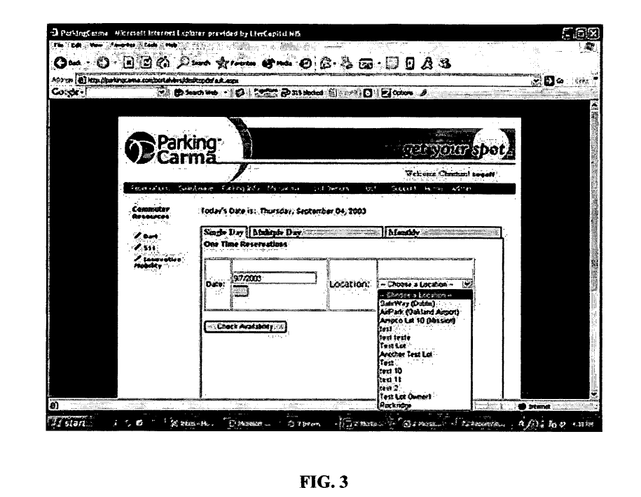

Users may access the system through industry standard web browsers. Any pages on the site that will require input or display of sensitive personal information may be secured using, for example, Verisign certificates and server based SSL. Most pages will be dynamically generated with information gathered from the database and the logic in the application layer. Each subscriber may have a “Home Page” that contains all pertinent information related to the users account. FIG. 3 depicts an example of a web based access page.

Some of the functions and features of some embodiments of the system enabled via web and wireless based access methods include:

1. Automated provisioning of new users (parking seekers)

2. Automated provisioning of new asset owners (parking providers) using downloadable forms from a web site and a workflow system that accepts inbound faxes and attaches them to users' accounts.

3. Administrator provisioning of new users (parking providers). A direct sales force may use this feature to open large targeted accounts.

4. A “Plan Ahead Parking” feature where users can pre-book parking. Users will give dates, times, and locations, and an intelligent matching logic system will provide suggested spaces. In some embodiments, users may be given up to fifteen minutes before their reservation time to cancel without penalty. Users may also be permitted specify a “notify me if better (e.g., closer, cheaper, covered, secured) parking becomes available before the time requested. If a better spot become available, the user may then switch spaces at no charge, but will be billed at the new parking space's price.

5. Available parking pre-scheduling provided for parking providers. This may include a calendar type function where parking providers input the dates and times that the spaces are available.

6. Real-time reporting. This feature allows users of the present invention, both parking seekers and parking providers, to view total charges, total money earned, etc.

7. Automated billing of the present invention users.

8. Map and route generation providing directions and any specific instructions (gate code, etc.) will be provided for each space.

9. Parking permits (both daily and monthly if applicable) can be printed from the users computer.

Cell Phones, Land Phones, Speech Recognition Based (TellMe Type System)

Users may access the system through any telephone, cell or land based system. They may dial a specified number or use a Sprint voice command keyword, for example, “parking,” which may be associated with an embodiment of the system of the present invention, in a manner similar to the way “weather” and “traffic” are associated with other systems. The system may be based on speech recognition and may utilize the industry standard Voice XML 2.0 or S.A.L.T standard. In some embodiments the telephony infrastructure may be implemented using an external third party service such as TellME or it may implemented internal to the system of the present invention. In either case, the underlying Voice XML code that provides the rules, pathways, and responses may be the same for each and may be transferable.

Some of the functions and features of some embodiments of the system enabled via phone and speech recognition-based access methods include:

1. Automated provisioning of new users (parking seekers).

2. “Priority Parking” immediate reservations. User enters location and time and the system retrieves available spaces all through spoken voice based system. User has the ability to instantly reserve the space and is charged. Directions to the space and special instructions are also provided. If no spaces are available, the system may be configured to call back the person with available spaces and may even automatically reserve the space for a predefined number of minutes. All information may be spoken to the user using text to speech technology.

3. Canceling of previously reserved parking spaces

4. Up to the minute billing charges

5. Alerts and calls when reserved time is almost up

6. Ability to extend parking time if permitted and available

Business Rules (Logic) Layer

The business rules are implemented in distinct functional modules that communicate with each other as needed. In implementations using Microsoft Corporation's Visual Basic .Net connected application, each module may correlate to a specific design class in VB.Net. Each of these classes may use subsequent “helper” classes or functions defined in a global class.

Best Fit Searching & Matching Algorithm Modules

1. Searching/Matching module—This module may be responsible for accepting search parameters, collating results from its sub-modules, and returning the best fit list of possible matches. This module in turn may call sub-modules to handle specific pieces of the searching logic.

2. Proximity Search module—This module may handle geo-coded based searching. This module may return lists of lots/spaces for example, either closest to the cell-phone based on driving time, or closest to the final destination based on walking time.

3. Location based identification module—This module may handle getting a geo-coded location using location-based services from the user's cell-phone, mobile device (if supported).

4. Parking-availability Algorithm module—This module may combine multiple factors such as the inventory of parking spaces in each lot, parking reservations made within the system of the present invention and the specific nature of the user's reservation request to suggest an optimal location for parking and/or predict future availability of parking spaces.

The following list includes examples of parameters that may be considered in the searching best-fit decision (this list is not all inclusive): Time of day, length of stay, size of vehicle, type of vehicle (Van, motorcycle, etc.), size of vehicle, walking distance to final destination, driving distance to parking (based on current cell phone location), price, price vs. distance, type of parking facility (valet, covered, street, open lot, etc.), parking company, validated parking based on specific destination, availability, additional features (car wash, oil change, etc.),

Asset Manager Administration Modules:

1. Dynamic pricing module—This module may analyze historical and current parking utilization and through custom proprietary mathematical modeling recommend the best potential price/time period to maximize gross revenues. This module may also enact on-the-fly dynamic pricing to best maximize revenue on an ongoing basis.

2. Asset Entry Module—Information pertaining to the parking asset may be gathered and persisted through this module. The assets may include macro level assets (Parking Structures, Lots) and micro level assets (individual spaces or spots).

3. Parking-availability Algorithm module—This module may combine multiple factors such as the inventory of parking spaces in each lot, parking reservations made within the system of the present invention and parking reservations made within the system of the present invention and manager-supplied data to forecast demand and suggest an optimal pricing strategy for parking on a particular day.

Reporting Modules

1. General graphing module—This module may be responsible for generating all pictorial graphs (line, trend, pie, etc.), for the reporting modules.

2. Asset Manager reporting module—This module may be responsible for returning all reports related to the asset owner/manager. Business analytic logic is contained in this module to return appropriate data for each report type and duration. Examples of some reports include: space/lot/multiple-lot utilization, trend analysis, gross/net/tax revenue, etc.

3. Enforcement Agent reporting module—This module may be responsible for providing real time or summary reports useful in enforcement such as information helpful to identify the location of vehicles that are in violation of any of the rules enforced by the system.

Data Layer

In some embodiments, a series of clustered Microsoft SQL Server OLTP database machines may be used to implement an information storage portion of the system. These databases may be located centrally or be geographically separated to meet future scaling needs. The real-time highly transactional data such as parking tariffs, individual parking lot and space availability, current billing cycle charges, etc. may be stored in these databases. These databases may feed into a clustered central data warehouse (OLAP) database used for historical data, reporting, trend analysis and billing.

The present invention OLTP database may be designed using the 3rd Normal form or Normalization. Certain tables have been excluded from the 3rd Normal Form where it would have adversely affected system scalability and performance.

Communication Layer

This layer may include the communication methods and protocols for remotely accessed devices used in the system of the present invention. Two of the device categories in the system include remote parking asset devices (e.g. parking transceivers and parking Internet gateways) and remote user communication channels (e.g. changeable message signs (CMS)).

Remote Parking Asset Devices

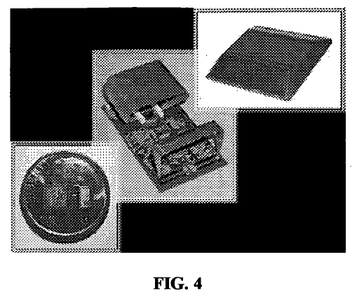

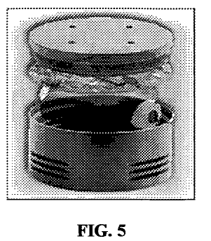

These devices are used to report real-time parking asset inventory, subscriber identification, and environmental information to the system of the present invention. Examples are depicted in FIGS. 4 and 5. These devices may either send data to the central communications broker at regular intervals, or the central communications broker for updates may poll them. Communication may be done over TCP/IP networks. In some cases TCP/IP encapsulated serial communication may be used over wide area networks (WAN).

The communication network may be any publicly accessible WAN. These include GSM phone networks, CDMA phone networks, DSL, T-1, etc. The PSTN network may also be used with certain other supplemental devices to communicate.

Remote User Communication Channels

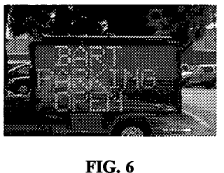

Changeable message signs may be used to display real-time parking asset inventory and other location specific parking asset information to consumers. An example CMS is depicted in FIG. 6. The present invention may work with a wide variety of temporary and permanent changeable message signs. Communication to these signs may be through either CDMA or GSM cellular networks, PSTN networks, or direct TCP/IP WAN connection.

In some embodiments, a message broker module may initiate the communication handshake with the changeable message sign and send the appropriate device specific commands to the sign.

System Level Considerations

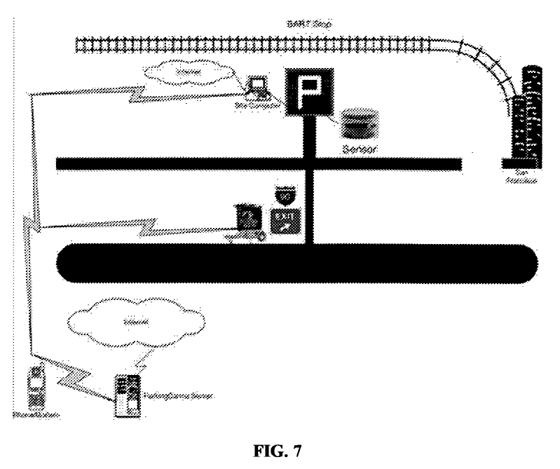

FIG. 7 depicts an example embodiment of various communication channels employed in the system of the present invention. In the depicted example, a system server determines, based on individual messages received from parking transceivers (e.g. sensors) via a parking Internet gateway (e.g. site computer), that parking at a train station is available. A CMS associated with the parking lot of the train station and located on the highway near the train station is sent a message from the system server directing the CMS to indicate that parking at the train station is available. Upon seeing the message on the CMS, a passing driver dials the system server via a cell phone and makes a reservation for a spot in the train station parking lot. The system server provides the information the driver needs to locate the parking spot and upon detecting the driver's arrival at the spot, a parking transceiver associated with the spot sends a message to the system server via the parking Internet gateway indicating the driver has parked. The system server charges the driver's account or credit card and dispatches a text or email message to the driver's cell phone that includes an electronic receipt.

The Application Programming Interface (API) is the underlying interface point that access points will access for services and functions. The API may be broken down into several broad functional areas or in some embodiments, hierarchical functions. In some embodiments using MS.NET, externally accessed API calls may be made through a MS.NET web-service based architecture. This architecture may allow for disparate systems to connect to the system of the present invention.

The system of the present invention may include the following administration functions: account provisioning, billing, alerts and notifications, parking search, proximity search, account management for providers, account management for users, location based services, communications broker (outbound), and communications broker (inbound).

The software architecture of the present invention may be based on the Microsoft.Net Architecture version 1.1, with the code written with ASP.NET and VB.NET. The web application, web services, and business intelligence layer software of the present invention may run, for example, on Microsoft Windows 2003 servers with IIS 6 installed. These machines may be configured for load balancing and/or clustering.

The OLTP and OLAP database layer of the present invention may run, for example, on Microsoft Windows 2003 Advanced Servers with Microsoft SQL Server Enterprise Edition installed. These machines may also be configured for clustering.

Some software embodiments of the present invention may run on almost any Intel/AMD based hardware platform, which supports Microsoft Windows 2003 Operating servers. In some embodiment, the preferred hardware configuration includes an IBM BladeCenter chassis running dual-Zeon processors and sufficient memory.

In some embodiments, production servers may be hosted in an off-site 3rd party data-center, which may provide adequate and properly filtered power as well as backup power in case of power outages. The data-center may manage climate issues and security in the data-center and specifically to the environment of embodiments of the present invention. Redundant Internet access may also be provided through this facility.

The voice recognition application used in embodiments of the present invention may be written with VoiceXML. The VoiceXML code may be portable between various providers, such as TellME, and internal to the system of the present invention. In some embodiments, the voice recognition and text to speech engines may be changed when the VoiceXML code is ported between providers.

Example Embodiments of Parking Asset Devices

In some embodiments, management of parking assets is enabled via a wireless device combining a vehicle detection sensor and a transceiver. These parking transceiver devices, nicknamed “turtles”, are operable to automatically sense the presence of a vehicle within a parking space and then transmit that information to a local communication hub or parking Internet gateway. These devices also leverage the transmissions of adjacent parking transceivers to the hub.

These parking transceivers may be packaged for installation on the road surface of each parking space much like current road “buttons”, known as bots-dots. One or more local IP network bridges or parking Internet gateways, nicknamed “snappers”, maintain wireless communication with a group of parking transceivers and links with database servers of the system of present invention via the Internet or other communications medium. As described above, the system maintains one or more databases of available parking assets and utilizes a resource allocation engine to allocate parking to service members. This allocation engine may be driven by a parking-availability algorithm that, as indicated above, may combine multiple factors such as the inventory of parking spaces in each lot, parking reservations made within the system of the present invention, and the specific nature of the user's reservation request to suggest an optimal location for parking and/or predict future availability of parking spaces.

Maintenance of the parking transceivers is minimized by use of robust parts and maximizing battery life. Use of passive sensor technology, ultra-low power transceivers and a power-saving communications strategy allows an extended installed life for each transceiver. For example, some embodiments may operate off a single battery for more than five years. Installation is simplified by a self-configuring network feature of the parking transceivers and the configuration of the parking transceivers themselves.

Sensor

In some embodiments, a magnetometer is used to accurately sense the presence of a vehicle. This sensor may be tuned to register vehicles of any size or shape (including motorcycles and high ground-clearance vehicles) within the parking space and ignore vehicles in adjacent spaces. Unless prevented by specific site requirements, the parking transceiver may be placed in the center of the parking space for greatest accuracy. The small size of the parking transceiver allows for this placement without posing a hazard to pedestrians. In some embodiments, other sensors such as heat and motion detectors may be used in addition to, or in alternative to, magnetometers.

Communication

In some embodiments, each parking transceiver's transmitted signal need only reach its neighboring parking transceiver. This allows parking transceivers to use of extremely low energy transceivers, for example, on the order of 0.01 watts. Microwatt transceivers provide several advantages. The most obvious is reduced power usage. Reduced power drain allows smaller batteries and/or extends battery life. The low power level also minimizes possible interference with other communication devices.

To further reduce energy requirements, transmission time may also be kept to a minimum. When a vehicle arrives or departs from a parking space, the parking transceiver senses the change and may transmit an update of its parking space status. Along with the space status, the message may identify the originating parking transceiver and thus, the parking space. The parking transceiver may retransmit this information several times to ensure that the message was received and retransmitted by other parking transceivers until it reached the snapper. In some embodiments a “handshake” protocol may be used wherein the parking transceiver receiving the transmission would reply to the originating parking transceiver that the message had been received and passed along. If necessary, the parking Internet gateway could send a confirmation back through the system to the originating parking transceiver.

When an adjacent parking transceiver receives a transmission from a neighboring parking transceiver it re-transmits the received data. This continues until the signal reaches the parking Internet gateway which forwards the information to the central servers of the system.

Each parking transceiver may also periodically send a signal confirming the ongoing status of the parking space. This would ensure that the status of the space in the database is correct even if the parking Internet gateway or network bridge did not receive the original status change notice. The timing of these periodic transmissions may be adjusted to maintain a balance between battery life, communications traffic and database accuracy.

Local Self-Configuring Mesh Network

The parking transceivers are able to self-configure themselves into a mesh network. The parking transceivers include the capability to locate each other and then inform the parking Internet gateway where they are in relationship to each other. In some embodiments, installation personnel merely correlate each specific parking transceiver to a given parking space during initial set-up. In some other embodiments, the parking transceivers locate themselves based on their relationships to adjacent parking transceivers. This may be accomplished, for example, by measuring received signal strength or in some embodiments via measurement of a time delay of an ultrasound signal.

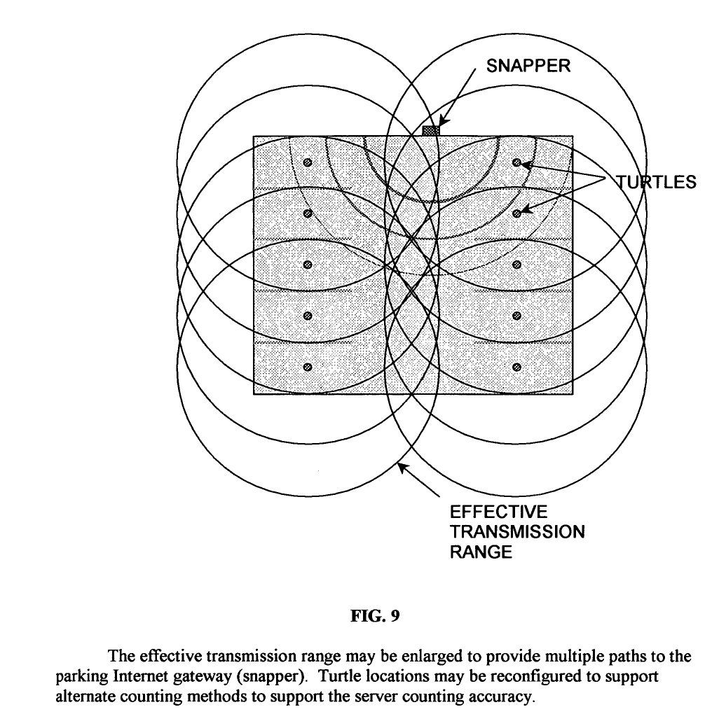

FIG. 9 depicts an example of a parking transceiver configuration for a small parking lot. This example drawing is not to scale. The overlapping circles represent an example of a transmission range of the parking transceivers. In other embodiments, the transmission ranges may be larger or smaller to include more or fewer transceivers within the range of a given parking transceiver. In some embodiments, the transmission range may be of a different shape. In a larger parking lot, the transmission range may allow any given parking transceiver to have multiple independent communication paths back to a parking Internet gateway.

Although not pictured in FIG. 9, each parking transceiver may include a configurable or fixed vehicle detection range. In some embodiments, the vehicle detection range may be limited to a singe parking space. In some embodiments, the vehicle detection range may cover multiple parking spaces and the parking transceiver may be able to able to determine the status of multiple parking spaces. In such embodiments, the vehicle detection ranges of multiple parking transceivers may overlap and the parking transceivers may be able to provide redundant information, thereby increasing the reliability of the system.

Self-Healing Network

If a parking transceiver fails for any reason the network simply adapts by routing the signal to the parking Internet gateway by way of other parking transceivers. This flexible network provides redundancy to the robust system.

Self-Maintenance Reporting

The network is able to perform self-maintenance reporting. The periodic status signals from each parking transceiver may not only identify the status of the parking space, but also provide evidence that the parking transceiver is still working. By tracking these signals the system may identify any non-functioning parking transceivers within the network. If a parking transceiver is suspected of being out of service, the parking Internet gateway may poll it specifically to ascertain its status. In some embodiments, power may be held in reserve by the parking transceiver exclusively to respond to special status queries from the parking Internet gateway. Likewise, a separate, isolated circuit, in some embodiments including a back-up transceiver, may be included in a parking transceiver to be used for reporting health status in certain special circumstances such as a failure or error mode.

In some embodiments, battery charge status information may be reported on a routine basis in response to a query from the parking Internet gateway.

Energy Consumption and Power Conservation Strategies

In some embodiments, power consumption may be controlled by several strategies. First, the inter-parking transceiver transmission distances may be minimized allowing the use of microwatt transceivers. Second, the information packets may be kept small, allowing short transmission times. Third, the number of transmissions may be kept to a minimum (while still balancing against maintaining database accuracy). In addition, various “sleep modes” may be employed to further extend battery life. Further, in embodiments using a magnetometer, such magnetic vehicle sensors are passive devices that do not draw energy.

Power Source

In some embodiments, lithium ion batteries may be used to provide power for the parking transceivers. Lithium batteries provide relatively high energy density which helps minimize the overall size of the parking transceiver. In some embodiments, alternative power sources may be used including solar, thermal, and direct wiring.

Packaging, Environmental Protection and the Physical Housing

The physical housing of the parking transceiver may protect the sensor, CPU, transceiver and batteries from traffic and the effects of road contaminants (e.g. water, salt, oil, gas, and coolant). In addition, the device may be resistant to damage by vandalism and normal road maintenance (e.g. street sweepers, snow-blowers, etc.).

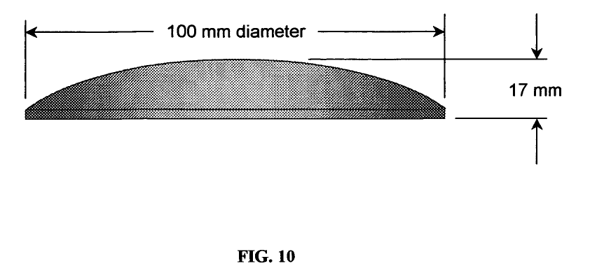

To minimize the likelihood of vandalism and to ensure compatibility with existing road maintenance equipment, the exposed portion of the parking transceiver may matches the size (approximately 17 mm high by 100 mm in diameter) and shape of a typical road button. In some embodiments, parking transceivers may be uniquely colored to permit easy identification of an associated parking space as a controlled/managed parking spot. In some embodiments, the color will be bright, and in some embodiments, reflective, to ensure that pedestrians are alerted to the parking transceivers and do not trip on them. The housing may be injection molded using a glass-reinforced plastic resin. Such a reinforced plastic housing provides structural integrity while maintaining electromagnetic transparency. In some embodiments, other materials may be used for the housing based on parameters such as the manufacturing cycle and durability. Glass-reinforced plastic resin has a manufacturing cycle time of 3 to 4 minutes and the process allows the magnetic sensor coil to be integrally molded. Once the housing with sensor coil is molded, the remaining electronics and battery pack may be installed and then hermetically sealed with epoxy resin. FIG. 10 is a drawing depicting an example shape of a parking transceiver housing.

Installation

In some embodiments, any above-grade portion of a parking transceiver may be molded to match the size and shape of standard road buttons. Thus, in some embodiments, parking transceivers may be installed in the same manner and using the same materials as conventional road buttons.

Temperature Affect on Performance

Although the heat generated within the parking transceivers by the low-power transceiver is minimal, some sites have potential for high ambient and road-surface temperatures. In some embodiments, to ensure system reliability, the parking transceivers may utilizes electronic components that operate reliably at high temperatures, for example, more than 160° F.

Batteries may be affected by temperature extremes; e.g. batteries typically display a drop in power at both low and high temperature extremes. Although lithium ion batteries also exhibit this typical drop in power level at low temperatures, their higher initial power density ensures adequate power to the parking transceivers in all but the most extreme cold weather conditions.

In some embodiments, a double or triple wall housing encasing the parking transceiver may be employed. The outermost wall may be the BOT DOT housing described above, and the inner wall(s) may be another wall similar to the outer wall. This embodiment using a double wall is a similar concept to a thermos design which helps to regulate the inside temperature. In some embodiments, there could be an anti-freeze coolant material between or within both walls that will help maintain a cool inner atmosphere in hot weather, while also helping maintaining an acceptable operating temperature in extreme cold weather.

Process Level View of Parking Transceiver Communication

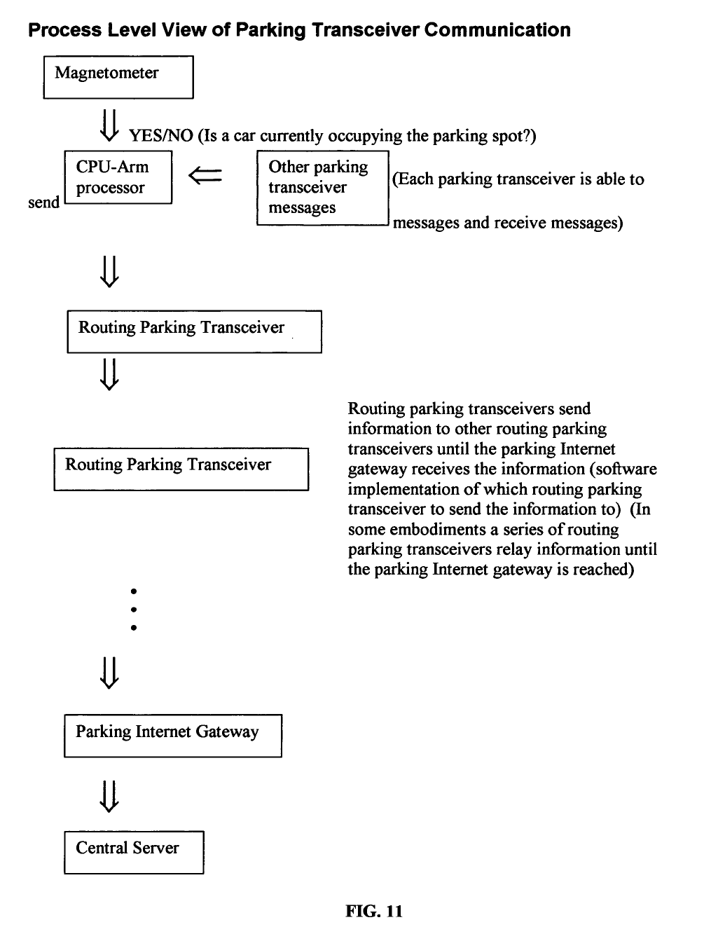

Turning to FIG. 11, an example flowchart illustrating a process level view of a parking transceiver's communication with the system is depicted. In some embodiments, a magnetometer outputs a YES/NO status that indicates whether a vehicle presently occupies a parking space associated with the parking transceiver. The parking transceiver's processor also receives messages from other parking transceivers. The information is forwarded via one or more other parking transceivers (acting as routing transceivers) to a parking Internet gateway which forwards the messages to the server. In some embodiments, routing parking transceivers merely echo an originating transceiver's message or forward the message a predetermined number of times or until acknowledgement that the message has been received. In some embodiments, routing transceivers modify the information packet to allow subsequent routing transceivers to direct the information to the correct destination.

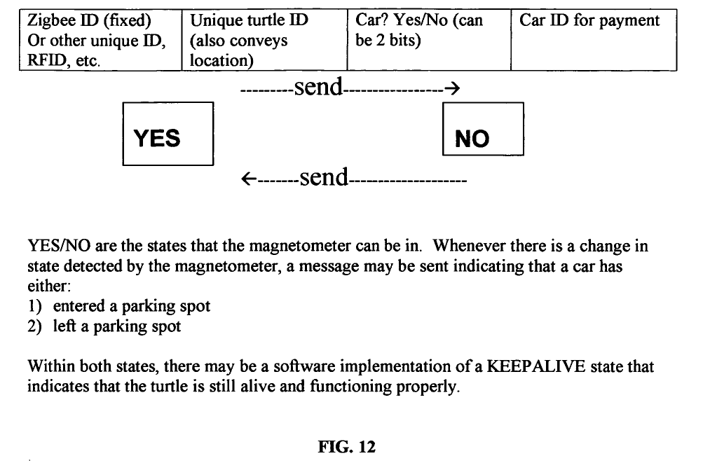

Turning to FIG. 12, a block diagram of an example of the information packet that may be transmitted by and between parking transceivers is depicted. In some embodiments, the information packet may include an information packet identification number, a source parking transceiver identification number (that may indicate the location of the parking transceiver), a vehicle present status indicator, a vehicle identification number (that may be used as an account identifier or otherwise used for collecting payment), a time stamp (not pictured), and other status information (not pictured). In some embodiments, a Zigbee ID (i.e. IEEE 802.15.4) may be used as the information packet identification number. In some embodiments using other communication protocols, other unique identification numbers such as those used with RFID systems may be used. In some embodiments, the vehicle present status indicator may be implemented using as few as one or two bits. A one bit (two state) indicator may merely indicate whether a vehicle was in the spot at the time the packet was sent or not, while a two bit (four state) status indicator may be used to indicate that either a previously unoccupied spot is now occupied (e.g. vehicle arrived), a previously unoccupied spot remains unoccupied (e.g. unused spot), a previously occupied spot is now unoccupied (e.g. vehicle departed), or a previously occupied spot remains occupied (e.g. continued use). In addition, additional status bits may also be used to indicate additional information such as, for example, vehicle size/type information. In some embodiments, a message may be sent to the server whenever a change in state occurs. In some embodiments, the “unused spot” state and the “continued use” state may serve as “keep alive” states (implemented in software) that are used to signal to the server that the parking transceiver remains operational and functioning properly.

An Add-On Module to Convert Existing Sensors to Parking Asset Devices

In some embodiments currently available products may be used to detect vehicles at the macro level in parking lots and/or garages. These types of products include, but are not limited to; loop detectors, mechanical gates, camera systems, and bar code scanners. To a limited degree, these devices are installed at parking garages/lots today. All of these systems are predominately “closed systems,” meaning that if data is collected, it is accessible only from a direct connection to the specific device. Collecting data from these devices is time and resource intensive and is by no means real-time.

In some embodiments of the present invention, an add-on module or component for these devices may be connected that enables them to be part of the “open system” of the present invention. The add-on module cost effectively “smart enables” existing parking counter devices, allowing asset owners to preserve their capital investment while gaining previously unavailable real-time access to aggregated and historical data from all of their lots/garages. Through an online service of the system of the present invention, asset managers may generate any number of predefined and custom reports on their parking usage data.

Sensor/Control Device

The mechanics behind parking counting sensors and control devices is relatively simple. In the presence of a vehicle or during the opening of a gate, an electrical circuit is closed, causing a voltage change in the circuit. The fluctuation of these changes are measured, counted, and stored in the device. The majority of existing parking counting sensors and control devices communicate this fluctuation count through standard 9-pin serial port connectors to a collector device that is either permanently connected or periodically manually attached.

Conversion Interface

The add-on module of the present invention interfaces with existing lot/garage counting sensor devices through serial connectors or through a direct wire attachment to the device's sensing circuit.

Communication

The add-on module is able to transmit the converted data in real-time to the system servers of the present invention. The add-on module supports multiple data transmission options through multiple chipsets. For example, embodiments of the add-on module may include support for embedded GSM data communication through existing GSM networks, embedded wireless (e.g. 802.11x) communication facilities, on-board Ethernet ports (e.g. RJ-45), on-board phone ports (e.g. RJ-11), and the like.

Health Reporting

In some embodiments, the add-on module may be configured to be able to report back to the system servers of the present invention its health status as well as the health status of the existing counting sensor.

Energy Consumption/Power Source

In some embodiments, the add-on module may operate off of either AC or DC power. In addition, an AC-only embodiment may operate on standard 110 v or 220 v unfiltered power. A DC-only embodiment may use, for example, lithium ion batteries. Lithium batteries provide relatively high energy density which permits minimizing the size of the add-on module.

Packaging and Environmental Protection/Physical Housing

In some embodiments, the add-on module may be implemented using different physical configurations depending on the environment at the remote location. A cabinet installed embodiment is engineered for installation in an environmentally protected environment. An open air embodiment may include a physical housing that protects the sensor, CPU, transceiver and batteries from traffic and the effects of road contaminants (water, salt, oil, gas, and coolant). In addition, such an embodiment is resistant to damage by vandalism and normal road maintenance (street sweepers, snow-blowers, etc.).

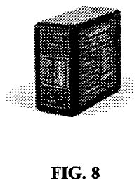

FIG. 8 depicts an image of an example embodiment of a standard loop detector enhanced internally with an add-on module. Such an embodiment may include a GSM, PSTN, and/or Wifi chipset, a motherboard, a RISC processor, a housing, a power supply, RJ-11 and/or RJ45 female connectors, a DB9 female connector, and support circuitry.

Alternative and Additional Embodiments

As mentioned above, parking is an increasing problem in most urban areas. Finding an appropriate parking space is a problem for drivers and efficiently using parking resources is a problem for the owners of parking spaces. In addition the time required to pay for parking is a negative for many users. On street parking with meters is limited by the need to have change. The use of parking lots with timed tags is also inconvenient. Users have to retain the ticket, hunt for parking spaces, and pay manually when they leave. The current situation results in an inefficient use of parking resources. These problems are the motivation for the described invention.

The described invention allows drivers to quickly locate available spaces and pay for them. This saves the driver time. It also allows parking space owners to rent out their spaces when they do not need them. This allows the parking space owners to maximize their revenue and allows more efficient utilization of scarce parking spaces in crowded urban areas.

In some embodiments, the system includes a collection of parking spaces and a distributed network of sensors connected to a central server. Users may subscribe to a service that accepts requests for parking spaces using the Internet from their computers, cell phones, and/or other devices. In addition, owners of spaces may allow their spaces to be rented out for certain periods when they are not using them. Subscribers may be informed of available spots based on a parking-availability algorithm that may combine multiple factors such as the inventory of parking spaces in a target geographic area, prior parking reservations made within the system of the present invention, and the specific nature of the user's reservation request to suggest an optimal location for parking and/or predict future availability of parking spaces (e.g., at the time the subscriber/driver arrives at the target geographic area). This allows the spaces to be more effectively used and also provides additional income to the parking space owner. In such embodiments, the system may identify optimal alternative spaces as a contingency if a reserved spot is not available when needed (e.g., someone else parks illegally).

In some embodiments, a website is provided that allows users to find their most desired parking space. The website may serve as a market place for parking spots. Users may be permitted to bid for highly desired spots. Providers may be permitted to offer promotions (or reverse bid) for less desirable spots. In some embodiments, vendors may contribute and display information about their spots individually and in some embodiments, all information may be displayed in a uniform matrix that allows users to sort parking spots in a manner that suits their preferences (e.g. via price, availability, location, etc.).

In some embodiments, the systems and methods of the present invention include methods to track which spaces are available and which are occupied, central servers which both track appointments for parking, authorized users, and owners and efficiently distributes this information, communications facilities that allow drivers to easily communicate with the server, find available parking spaces and pay for them.

Tracking the availability of parking spaces is accomplished in different ways depending on the type of parking facility being controlled. The system can be applied to many classes of parking facilities. A “closed” facility includes a typical parking lot or structure with controlled entrances and exits. An “open” facility includes collections of metered spaces on a street.

In an open facility, each space may be equipped with a sensor (called a parking transceiver). This sensor can detect the presence of a vehicle, read its identity using for example, a radio frequency identification (RFID) system or other identifying means (e.g. Zigbee, Bluetooth, IEEE 802.11b/a/g, etc.) as well known in the current art, and relay this information, using a wireless network, to the central server.

The parking transceivers may be easily installed in the same manner as reflective traffic dots. It is desirable to allow a staff that is unfamiliar with wireless network design to install the system.

Typically these parking facilities are geographically diverse. In addition, the organization of the parking spaces is somewhat random. Accordingly, the wireless network to be used will preferably be a self-organizing mesh network although any network that is practicable may be used. Essentially, each parking transceiver can act as a data originator and data router/forwarder. This allows the parking transceivers to be just placed on the road and then self organize into a network, which ultimately connects to the central server using, for example, the Internet. While the use of a self-organizing network is not required for the system to operate, it is desirable. The reason is that it is a significant advantage for the system to be able to be installed by staff that is unfamiliar with wireless network design. Preferably, the parking transceivers may be easily installed in the same manner as reflective traffic dots.

In closed facilities the ability to determine space availability down to a specific parking space is also useful, but in some applications such as small closed parking lots, just the number of spaces available is sufficient information. Thus a a small sub set of the micro-mesh can be used. This can be accomplished by monitoring the entries and exits into and out of the lot. This turns the monitoring system into a state machine, given knowledge of the initial number of vehicles, and assuming perfect reliability, the system will always know the number of parked vehicles. However in practice, the system may need to be reset periodically by manually counting the number of vehicles. The advantage of this system is cost and complexity. With only a few sensors, a self-organizing network is not necessary through out the lot, only at each entrance and exit.

As described in detail above, in some embodiments, an add-on device may be connected to existing gates or sensors of closed facilities to inexpensively allow the integration of additional parking inventory to the system.

In some embodiments, the parking transceiver's ability to identify a vehicle (e.g. via RFID or Zigbee) in a specific space may be used to lower the cost of parking space enforcement. It is not, however, required for the proper operation of the system. In some embodiments, parking transceivers may not be used at all and parking spaces under management of the system of the present invention may simply be marked as such using paint or signage. In such embodiments, conventional enforcement methods supplemented with information from the server may be applied, e.g. police patrols, parking tickets and towing. The enforcement personal can just query the server for the authorized license plate number in each space.

In some embodiments using a parking transceiver, the enforcement process is significantly more efficient. In this case, the server notifies the enforcement staff when an unauthorized vehicle is in a parking space. This significantly improves enforcement and lowers operating cost for the parking facility owner.

In some embodiments, a central server tracks such things as the availability of spaces; databases of users, vehicles, spots/parking transceivers and add-on devices; user payment/account information; and communicates with both the users and the spaces. It may service requests for spaces by matching the geographical location of the desired space, the time the space is needed, and the cost of the space.

In some embodiments, to use the system, customers create an account. They typically enter payment information, data on their vehicles, and may be provided with an RFID tag if desired.

When a user requests a parking space, he may specify the price he is willing to pay, the time required, and the location. The server may then match the request with one or more spaces in the database of available spaces and inform the user of the options.

In some embodiments, other means may be provided for providing a parking space to a user. For example, using the location based feature of a cell-phone or speaking the current address, a user can ask the system of the present invention find an available space closest to the user at that time. In some embodiments, the system may support requests for the closest parking space to a users ultimate destination based on walking distance and convenience and not necessarily based on driving distance. In some embodiments, the system may additionally consider other attributes such as size of vehicle, type of space, covered, level of security, intended duration of stay, etc. in determining the optimal space for a particular user.

In some embodiments, to allow users in vehicles to interface with the system, the server may communicate via a phone line/voice connection. In some embodiments, the system may also be accessed via the Internet directly from a personal computer.

An integrated parking management system can serve an industry with a $26 billion economic impact. Over 105,000,000 paid spots are not optimized and poorly marketed. Developers and operators face new pains caused by density and technology. Population and VMT are increasing exponentially while access is constrained at best. Operators are facing increased service costs with no clear return on investment. Existing systems do not dynamically integrate or communicate, and are more costly. Wireless data acquisition, distribution capabilities, and consumer usage are viable. The dynamic system of the present invention leverages installed infrastructure with unique technology. Operators and developers get a sound return on investment: $86 million in revenue in 5 years.

The system of the present invention is a user-based dynamic wireless solution that profitably addresses parking resource issues. Bringing a technology enabled service to the global parking industry to change the way parking works today. The present invention: increases revenues to communities and constituents; increases parking convenience; increases parking availability in dense commercial and residential neighborhoods; reduces congestion from parking searches and double-parking; reduces cost of doing business for the delivery industry; reduces the environmental impact of growth; and provides usable real-world data for planning and asset managers.

By leveraging technologies such as wireless services, wireless equipment, mobile phones, the internet, transit systems, and telematics, the present invention provides smart, flexible, and efficient solutions for managing parking resources. The architecture and hardware systems of the present invention enable: optimized dynamic space sharing; real time matching of users with providers; value-based pricing; premium reservations; real-time parking information and guidance; cashless billing (reduced leakage); and capture of raw data for research and analysis. The present invention delivers a high return on investment for parking asset owners and the users of this service with relatively low risk.

The above description provides illustrative examples of many different aspects and embodiments of the present invention. Accordingly, none of the statements above should be interpreted as limiting the scope of the invention. The inventors intend that the systems and methods of the present invention may be practiced in many different ways and that embodiments, like the figures, are meant to be illustrative of embodiments of the methods and systems described herein, but not their only embodiments. Further, the inventors note that the embodiments shown in the figures are not to scale and any dimensions provided or otherwise represented are not intended to be limiting. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention.

Further, while the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. An apparatus comprising:
a server; and
a plurality of parking transceivers in communication with the server,
wherein each of the parking transceivers is operative to detect the presence of a vehicle in an associated parking spot and communicate a status of the parking spot to the server, and
wherein the server is operative to direct each of a plurality of subscribers to a parking spot based upon the status of the parking spot and one or more parameters specified by each of the plurality of subscribers.
